(19) United States
(12) Patent Application Publication
(10) Pub. No.: US 2004/0022073 A1
(43) Pub. Date: Feb. 5, 2004

(54) RESONANT CONVERTER HAVING A SELF INDUCTANCE

(76) Inventor: Stig Munk Nielsen, (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/240,412

(22) PCT Filed: Mar. 28, 2001
(86) PCT No.: PCT/DK01/00208

(30) Foreign Application Priority Data
Apr. 3, 2000 (DK) PA 2000 00553

(51) Int. Cl. H02M 3/335

(52) U.S. Cl. 363/17

(57) ABSTRACT

A resonant converter for supplying an electrical consumer (D), wherein the input circuit of the resonant converter forms a voltage centre (N) which is connected through a self-inductance (L1) to a first node (B), from which there is a connection through capacitors (C1, C2) to a positive supply potential and a negative supply potential, wherein the self-inductance (L1) is magnetically coupled to a magnetizing device (Ls) which is magnetized in alternating directions by means of an electronic circuit (I pulse). The resonant converter has the characteristic that the first node (B) is connected via the self-inductance (L1) to the voltage centre (N) which is in direct connection with a first set of electronic switches (S3, S4), which set up a connection to at least one output (D) when the switches (S3, S4) are closed, wherein the positive (A) supply voltage and the negative (B) supply voltage, respectively, are connected to the output (D) through a second set of electronic switches (S1, S2), wherein the electronic switches (S1, S2, S3, S4) are opened and closed in dependence on an overall control system. This makes it possible to provide a resonant converter with the smallest possible power loss.

The invention relates to a resonant converter for supplying an electrical consumer (D), wherein the input circuit of the resonant converter forms a voltage centre (N) which is connected through a self-inductance (L1) to a first node (B), from which there is a connection through capacitors (C1, C2) to a positive supply potential and a negative supply potential, wherein the self-inductance (L1) is magnetically coupled to a magnetizing device (Ls) which is magnetized in alternating directions by means of an electronic circuit (I pulse).

U.S. Pat. No. 5,047,913 discloses a resonant converter in which the resonant circuit is formed by two series-connected capacitors, with connection to the positive and negative potentials of a supply voltage. There is a connection to a coil through a first set of semiconductor switches from a centre between the capacitors. The other connection of the coil is connected to a centre in a second set of electronic switches, which are connected to the positive potential and to the neutral potential, respectively, of the supply voltage. The other connection of the coil also provides a connection to a centre between two other series-connected capacitors, which are connected to the positive and neutral potentials of the voltage supply. Moreover, the other connection of the coil is connected to a second self-inductance from which there is a connection to the output of the circuit.

However, the use of electronic switches between capacitors and self-inductance involves an undesired voltage drop if the switches consist of semiconductors. If great currents are to be carried, a great power loss occurs.

The object of the invention is to provide a resonant converter with the smallest possible power loss.

This can be achieved by a resonant converter like the one described in the opening paragraph, if it is constructed such that the first node (B) is in direct connection with a first set of electronic switches which set up a connection to at least one output when the switches are closed, wherein the positive supply voltage and the negative supply voltage, respectively, are connected to the output through a second set of electronic switches, wherein the electronic switches are opened and closed in dependence on an overall control system.

This ensures that a current running from the supply voltage to the output just runs through a semiconductor in the forward direction. Because the voltage at the node fluctuates with the resonant frequency of the circuit between the positive and negative values of the supply voltage, semiconductor switches may be opened at times with a minimal voltage drop which is ideally zero. This reduces the on and off losses of the semiconductors in the resonant converter, and transfer of great power can take place with a low generation of heat, thereby reducing the cooling requirements.

The first node (B) may be connected to at least two semiconductor components which are connected to the positive voltage potential and to the negative voltage potential. It is ensured hereby that the voltage at the node cannot exceed the positive voltage supply and cannot be smaller than the negative voltage supply.

The first node (B) may also be connected to several branches, each of which consists of a first set of electronic switches which set up a connection to outputs when the switches are closed, wherein the positive voltage supply and the negative voltage supply, respectively, are connected to the output through a second set of electronic switches, wherein the electronic switches are opened and closed in dependence on an overall control system. The resonant converter may hereby be used for a multi-phased AC system. On the basis of the control of the semiconductors of the individual branches, each branch can control a phase which may be phase-shifted an arbitrary number of degrees.

The self-inductance, together with the capacitors, may form a resonant oscillation system, wherein the oscillations are maintained by the electronic control system in dependence on the actual need on the outputs of the resonant converter. The amplitude of the resonant oscillation may hereby be maintained optimally without exceeding the potential of the supply voltage and without getting below the negative supply. If the oscillation amplitude can keep its peak to peak value close to the supply voltage, opening of the semiconductors by means of the control system may be optimized so that opening takes place with a minimal voltage drop across the semiconductors.

The resonant circuit may be designed so that the electronic switches automatically close at an opposite current direction. Then, the control system is only to be constructed such that it can open the semiconductors.

The electronic switches may advantageously be opened or closed while there is a low voltage drop across the switches. A low power dissipation may be achieved hereby while the semiconductors change state.

The circuit may be incorporated in a multi-phased frequency converter. The circuit may hereby be used for motor control.

The circuit may also be used in a DC/DC converter. Control signals for the semiconductor switches may be generated by the overall control system by means of a sigma delta converter. The control signals may hereby be formed in a simple manner using a minimum number of components.

The overall control system may contain a table of a plurality of allowed logic states, wherein another plurality of non-allowed states are excluded, wherein the non-allowed states cause short-circuit in the branches of the converter. Possible short-circuit states may hereby be eliminated effectively. Especially very brief short-circuits in a converter branch are critical, because brief short-circuits of a duration of a few nanoseconds are difficult to detect, but very great power is dissipated in the semiconductors.

The invention will be explained below on the basis of sketches, where

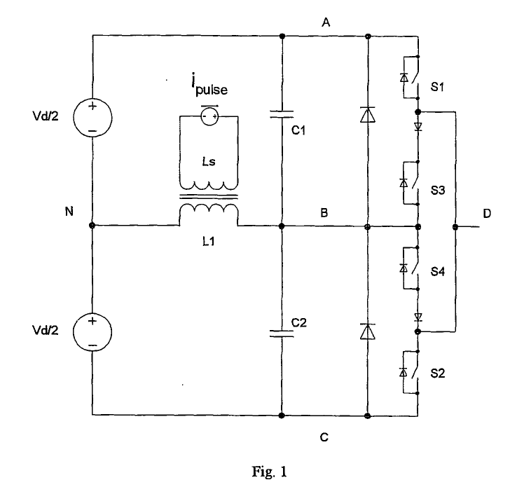

FIG. 1 shows a single branch of the proposed converter, where

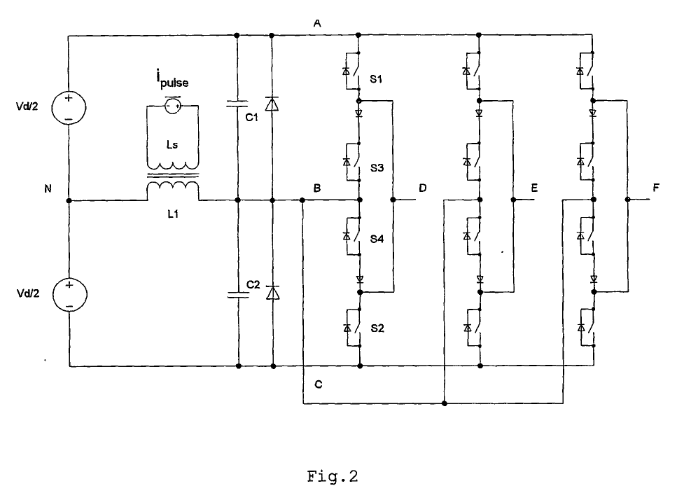

FIG. 2 shows a three level resonant converter with three output branches D, E and F, where

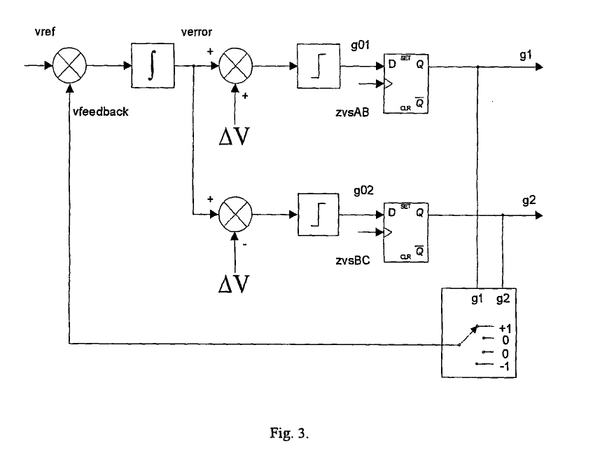

FIG. 3 shows a sigma delta modulator, where

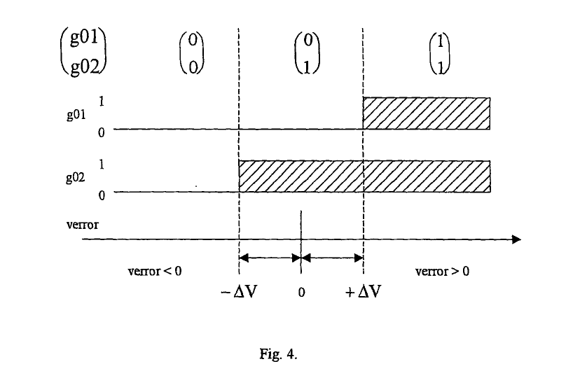

FIG. 4 shows an SDM signal (g01, g02), where

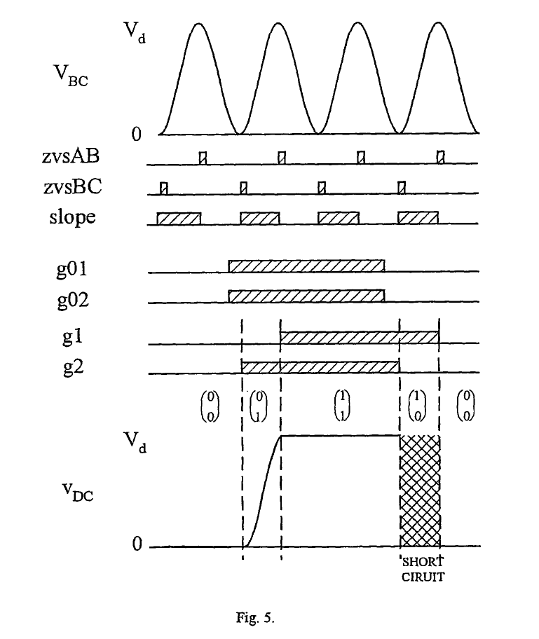

FIG. 5 shows a simple synchronization of a resonant converter, where

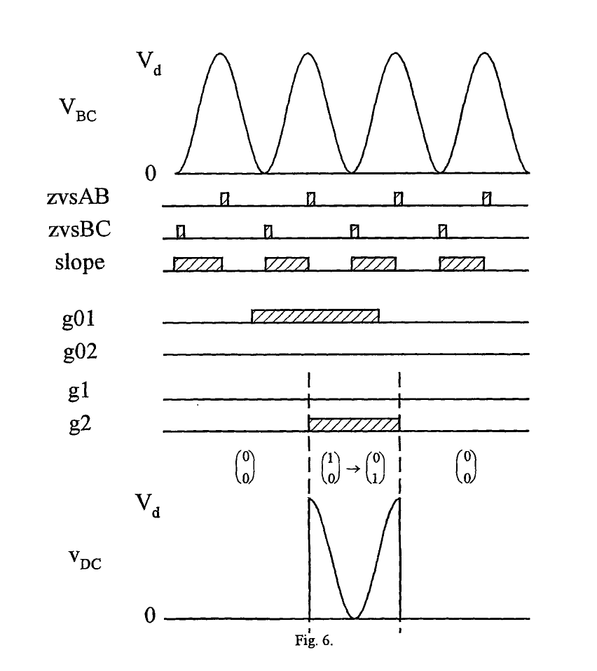

FIG. 6 shows an alternative simple elimination of short-circuit states, where

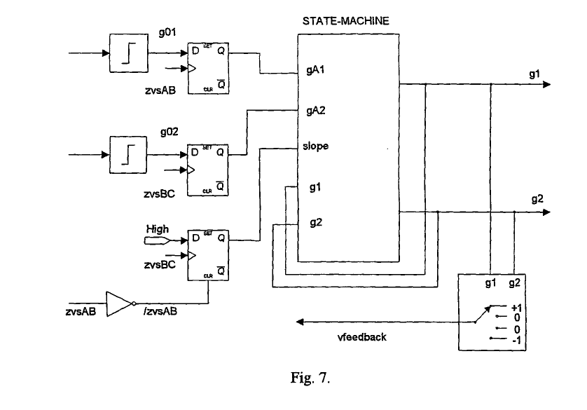

FIG. 7 shows a modified circuit, where

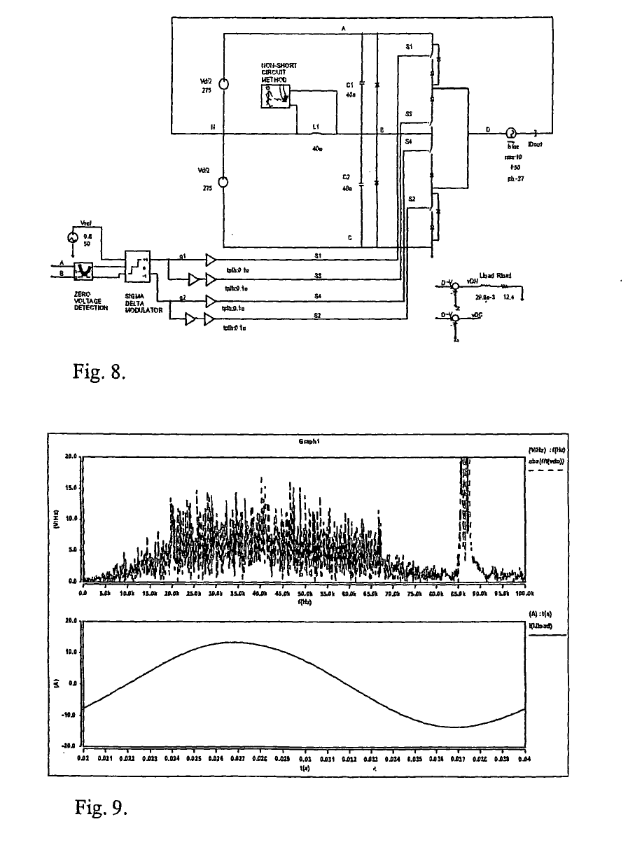

FIG. 8 shows the simulation of a one-phase converter, where

FIG. 9 shows output voltage and current curves, where

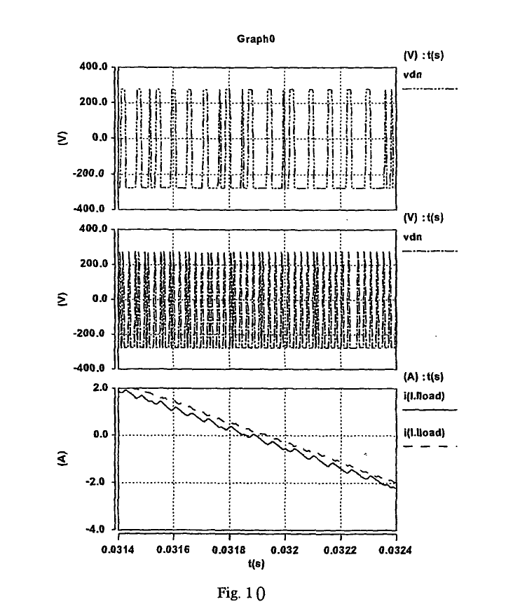

FIG. 10 shows the distribution of current and the quality of the output voltage, and where

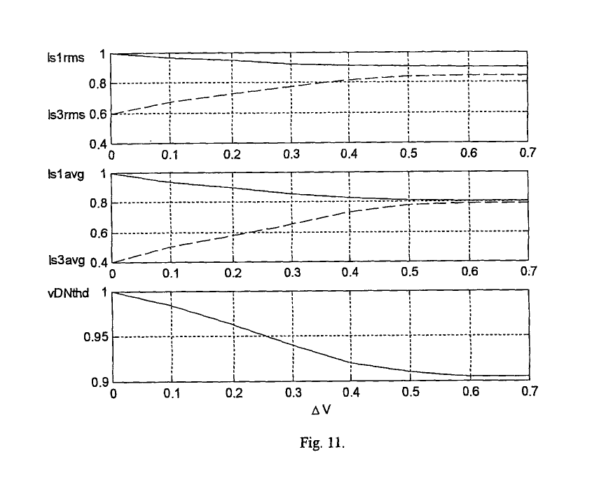

FIG. 11 shows the root-mean-square current (RMS) and the AVG current at S1 and S2 as well as the THD of the phase voltage V_{DN} as a function of ΔV.

At the point B in FIG. 1 the voltage VBC oscillates between V_{d} and 0, and the two diodes in parallel with C1 and C2 clamp the voltage. The resonance is controlled by the current source iₚᵤₗₛₑ, which is magnetically coupled to the resonant circuit via L_{S} and L₁. Iₚᵤₗₛₑ supplies the resonant circuit with an appropriate level of energy and compensates for the losses of the resonant circuit. Iₚᵤₗₛₑ is adjusted according to the load conditions. The control of the resonance is completely independent of the main switches, and hereby the resonance is easily made reliable, and high frequency stress is avoided at the main switches.

With an oscillating voltage V_{BC} at point B, soft switching of the main switches is possible. A soft switch commutation from switch S1 to switch S2 is obtained by turning S1 off when the voltage V_{AB} is zero (zvsAB=true), and at the same turning S3 and S4 on. When V_{BC} reaches zero (zvsBC=true), S3 and S4 are turned off, and S2 is turned on.

| $( \begin{matrix}g1 \\ g2\end{matrix} )$ | $( \begin{matrix}1 \\ 1\end{matrix} )$ | $( \begin{matrix}1 \\ 0\end{matrix} )$ | $( \begin{matrix}0 \\ 1\end{matrix} )$ | $( \begin{matrix}0 \\ 0\end{matrix} )$ |
|---|---|---|---|---|
| V_{DN} | Vd/2 | short | 0 | −Vd/2 |
| | | cir. | | |
| V_{DC} | Vd | short | Vd/2 | 0 |
| | | cir. | | |

The converter has three levels defined as S1=ON, where V_{DC}=V_{d}, and S2=ON, where V_{DC}=0. The third level is reached when S3+S4=ON in one resonance period, where the average of V_{DC} is the same as V_{d}/2.

In FIG. 2 a complete three-phase converter is shown. The wiring of the switches S3 and S4 enables the use of standard dual-pack IC modules. The diodes connected in parallel to C1 and C2 may be eliminated by sufficient control of the switches S3 and S4, but due to safety precautions they are not removed herein.

If soft switching is used instead of hard switching of the switches, the switch losses are reduced, but it leads to a greater loss in resonant circuits.

The conduction losses are distributed between S1, S3, S4, S2 and diodes. Since the transistor losses are significantly greater relative to the diode losses, only the transistor losses are considered in the following. The conduction time is determined by the modulator which produces an output signal controlling the switches, and the modulator just produces two output signals because S1 is inverse of S3 (S1=/S3), and S2 is inverse of S4 (S2=/S4).

A branch vector is defined as (g1,g2)′ where g1 controls S1+S3, and g2 controls S2+S4. Four combinations are possible. Table 1 shows the relation between branch vector and branch voltage V_{DN} and V_{DC}.

FIG. 3 shows a sigma delta modulator (SDM) which is simple and efficient.

Sigma delta modulator: signals (g1,g2)′ are synchronized with zero voltage intervals zvsAB and zvsBC.

The sigma delta modulator has an internal analog feedback with three states (1,0,−1) and a 2-bit digital output (g1,g2)′. The distribution of current between S1,S2 and S3+S4 depends on the hysteresis voltage band ΔV shown in FIG. 4.

FIG. 4 shows an SDM signal (g01,g02)′ as a function of integration where error signals error.

The states (g01,g02)′ cannot be transferred directly to the switches, and a change in the state of the branch may have as a result that certain restrictions and time requirements must be kept to prevent the branch from short-circuiting or hard switching.

FIG. 5 shows a simple synchronization of g01,g02 with zvsAB and zvsBC, but the shown synchronization of g01 and g02 is not sufficient to prevent a short-circuit.

Limiting the change in the state of the branch to zero volt intervals g1 at zvsAB and g2 at zvsBC is no guarantee of a rational state. FIG. 5 shows a situation of short-circuit. Solving the problem by replacing the state (1,0)′ by (0,1)′ might seem to be an easy solution, but this is not the case. It can be observed in FIG. 5 that an identical g01 and g02 is obtained by using ΔV=0.

In FIG. 6 it is also shown how a simple elimination of the short-circuit state is not enough to guarantee a correct control of the branch. Here, the short-circuit is avoided, but an undesirable hard switching occurs. To avoid the hard switching and the short-circuit it is necessary to analyze all the possible states.

The question is how the changes in the branch state can be limited to be allowed changes in the state. Before changing the state of the branch, it is necessary to evaluate the latched values of (g01,g02), and based on the result of the evaluation the signals of the branch state (g1,g2)′ are changed. The latched values of (g01,g02)′ are re-named (gA1,gA2).

As shown in FIG. 6, it is not allowed to change the state of the branch from (0,0)′ to (0,1)′ when the slope of the resonant link voltage VBc is negative. The state (g1,g2)′ of the branch must be in accordance with the slop of VBC.

Five logic level signals will be described below: (gA1, gA2, slope, g1, g2)

The five signals give complete information on the state of the branch, and in total there are 32 combinations. Some of these are allowed, others are not. Each combination is considered, and a look-up table or a state table is created.

FIG. 7 shows a modified circuit

TABLE 2
State machine used in modified SDM.

| | |
|---|---|
| States | New |

| No. | slope | g1A | g2A | g1 | G2 | g1 | g2 |
|---|---|---|---|---|---|---|---|
| 0 | 1 | 1 | 1 | 1 | 1 | 1 | 1 |
| 1 | 0 | 1 | 1 | 1 | 1 | 1 | 1 |
| 2 | 1 | 0 | 1 | 1 | 1 | 1 | 1 |
| 3 | 0 | 0 | 1 | 1 | 1 | 0 | 1 |
| 6 | 1 | 0 | 0 | 1 | 1 | 1 | 1 |
| 7 | 0 | 0 | 0 | 1 | 1 | 0 | 1 |
| 8 | 1 | 1 | 1 | 0 | 1 | 0 | 1 |
| 9 | 0 | 1 | 1 | 0 | 1 | 1 | 1 |
| 10 | 1 | 0 | 1 | 0 | 1 | 0 | 1 |
| 11 | 0 | 0 | 1 | 0 | 1 | 0 | 1 |
| 14 | 1 | 0 | 0 | 0 | 1 | 0 | 0 |
| 15 | 0 | 0 | 0 | 0 | 1 | 0 | 1 |
| 24 | 1 | 1 | 1 | 0 | 0 | 0 | 1 |
| 25 | 0 | 1 | 1 | 0 | 0 | 0 | 0 |
| 26 | 1 | 0 | 1 | 0 | 0 | 0 | 1 |
| 27 | 0 | 0 | 1 | 0 | 0 | 0 | 0 |
| 30 | 1 | 0 | 0 | 0 | 0 | 0 | 0 |
| 31 | 0 | 0 | 0 | 0 | 0 | 0 | 0 |

The contents of the state table is shown in table 2.

In table 2, only 18 of the 32 states are shown after the elimination of all non-allowed states (1,0)′.

FIG. 8 shows the simulation of a one-phase converter, where a current source feeds the converter with an RMS current of 10 A and a phase angle of −37 degrees.

FIG. 9 shows output voltage and current curves using ΔV=0.5. The significance of ΔV is illustrated in FIG. 10, where a zoom on the phase voltage V_{DN} and current is shown, using ΔV=0 in the upper curve which shows V_{DN}, and using ΔV=0.5 in the middle curve which shows V_{DN}. Increasing ΔV also increases the number of branch states that generate half DC link voltage.

It is clear from FIG. 10 that the current distribution and the output voltage quality change with ΔV.

A series of simulations is carried out, where ΔV is changed from 0 to 0.7, and then the RMS current and the AVG current in S1, S3, S4 and S2 are calculated, it being noted that the RMS and AVG values of S1 and S2 are the same. The same is observed with the current in S3 and S4. It is therefore only necessary to show the RMS and AVG current values of the current in S1 and S3. Furthermore, the THD of the phase voltage V_{DN} is calculated.

The results are shown in FIG. 11, and it is noted that the current distribution between the switches becomes more equal as ΔV increases. The TDH level is also improved as AV increases, however no or just a slight improvement occurs after ΔV=0.5 has been reached.

1. A resonant converter for supplying an electrical consumer (D), wherein the input circuit of the resonant converter forms a voltage centre (N) which is connected through a self-inductance (L1) to a first node (B), from which there is a connection through capacitors (C1, C2) to a positive supply voltage and a negative supply voltage, wherein the self-inductance (L1) is magnetically coupled to a magnetizing device (Ls) which is magnetized in alternating directions by means of an electronic circuit (I pulse), characterized in that the first node (B) is connected via the self-inductance (L1) to the voltage centre (N), wherein the first node (B) is directly connected to a first set of electronic switches (S3, S4) which set up a connection to at least one output (D) when the switches (S3, S4) are closed, wherein the positive (A) supply voltage and the negative (C) supply voltage, respectively, are connected to the output (D) through a second set of electronic switches (S1, S2), wherein the electronic switches (S1, S2, S3, S4) are opened and closed in dependence on an overall control system.

2. A resonant converter according to claim 1, characterized in that there is a connection from the first node (B) to at least two semiconductor components which are connected to the positive (A) and negative (B) supply potentials.

3. A resonant converter according to claim 1 or 2, characterized in that the first node (B) is connected to several branches, each of which consists of a first set of electronic switches (S3, S4) which set up a connection to outputs (D, E, F) when the switches (S3, S4) are closed, wherein the positive (A) supply voltage and the negative (B) supply voltage, respectively, are connected to the output (D) through a second set of electronic switches (S1, S2), wherein the electronic switches (S1, S2, S3, S4) are opened and closed in dependence on an overall control system.

4. A resonant converter according to one of claims 1-3, characterized in that the self-inductance (L1), together with the capacitors (C1, C2), form a resonant oscillation system, wherein the oscillations are maintained by the electronic control system in dependence on the actual need on the outputs of the resonant converter.

5. A resonant converter according to one of claims 1-4, characterized in that the electronic switches automatically close at an opposite current direction.

6. A resonant converter according to one of claims 1-5, characterized in that the electronic switches are opened or closed while there is a low voltage drop across the switches.

7. A resonant converter according to one of claims 1-6, characterized in that the circuit is incorporated in a multi-phased frequency converter.

8. A resonant converter according to one of claims 1-7, characterized in that the circuit is incorporated in a DC/DC converter.

9. A resonant converter according to one of claims 1-8, characterized in that control signals for the semiconductor switches are generated by the overall control system by means of a sigma delta converter.

10. A resonant converter according to one of claims 1-9, characterized in that the overall control system contains a table of a plurality of allowed logic states, wherein another plurality of non-allowed states are excluded, wherein the non-allowed states cause short-circuit in the branches of the converter.
